(19) United States
(12) Patent Application Publication
(10) Pub. No.: US 2022/0379940 A1
(43) Pub. Date: Dec. 1, 2022

(54) Electronic Tech Table

(71) Applicant: Corwin Watson, St Louis, MO (US)

(72) Inventor: Corwin Terrell Watson, St Louis, MO (US)

(21) Appl. No.: 17/335,775

(22) Filed: Jun. 1, 2021

(51) Int. Cl. B62B 3/02; B62B 3/00

(52) U.S. Cl. CPC B62B 3/022; B62B 3/005; B62B 2206/06; B62B 2205/06

(57) ABSTRACT

A raisable and lowerable storage system is provided comprising a steel container with multiple compartments, a scissor lift device attached to at least a bottom area of the container, wheels attached to a lower area of the scissor lift device. The scissor lift device raises and lowers the container to a desired level. The scissor lift device raises the container to a maximum height of about eight feet. The wheels support the container as the container is placed into a bed area of a vehicle for transportation. The wheels roll along tracks attached to the bed area of the vehicle. The container is secured before the vehicle begins moving to prevent the container from rolling about as the vehicle moves. A battery in the container is charged while the container is in a secured position and the vehicle moves.

### FIELD OF THE INVENTION

The present disclosure is in the field of storage products. More particularly, the present disclosure provides a steel box with many drawers and compartments with a hydraulic lifting apparatus and wheels for movement about a job site and in a truck or van outfit with tracks as provided herein.

### BACKGROUND

Tradesman, technicians, maintenance workers, and construction workers often store their tools in toolboxes, tool carts, and other similar storage containers. Lifting these containers from a truck or van and transporting them to the location where work is to be performed can be difficult.

The containers may be heavy and often require more than one person to carry. Lifting these containers can cause serious injury. Carrying tools in hand or on a belt can be inconvenient and dangerous, especially when using tools on a ladder.

### SUMMARY

In an embodiment, a raisable and lowerable storage system is provided comprising a steel container with multiple compartments, a scissor lift device attached to at least a bottom area of the container, wheels attached to a lower area of the scissor lift device. The scissor lift device raises and lowers the container to a desired level. The scissor lift device raises the container to a maximum height of about eight feet. The wheels support the container as the container is placed into a bed area of a vehicle for transportation. The wheels roll along tracks attached to the bed area of the vehicle. The container is secured before the vehicle begins moving to prevent the container from rolling about as the vehicle moves. A battery in the container is charged while the container is in a secured position and the vehicle moves. The container provides at least one electrical outlet for electrical tool connection. The scissor lift device is hydraulic. The hydraulic characteristic promotes raising the container to a level even with the bed area of the vehicle.

In another embodiment, a portable electronic table is provided. The table comprises a steel box with a plurality of storage drawers, a scissored retracting and expanding forklift device, and a rechargeable battery for powering at least the forklift device. The forklift device raises and lowers the box. Wheels below the forklift device promote movement of the steel box. The forklift device raises the box to a level of a bed of a vehicle. Once at the level of the bed of the vehicle, the forklift device is retracted and wheels below the forklift device facilitate rolling the box into the vehicle. The wheels ride along tracks affixed to the bed of the vehicle.

In yet another embodiment, a vehicle-mounted rail system for securing storage devices during transit is provided. The system comprises a vehicle with a horizontal bed surface, parallel rails affixed to the bed surface, the rails supporting a first storage device, and a clamping mechanism proximate the rails for affixing the first storage device during vehicle movement. the rails support wheels of the first storage device as the device is placed into the vehicle and secured to the clamping mechanism. A battery in the first storage device is recharged by the vehicle while the device is stowed and held by the clamping mechanism during movement of the vehicle. Distance between parallel rails is adjustable based on differing sizes of storage devices to be stowed and transported.

### BRIEF DESCRIPTION OF THE FIGURES

FIG. 1 is a diagram of an electronic tech table in accordance with an embodiment of the present disclosure.

FIG. 2 is a diagram of an electronic tech table in accordance with an embodiment of the present disclosure.

FIG. 3 is a diagram of an electronic tech table in accordance with an embodiment of the present disclosure.

FIG. 4 is a diagram of an electronic tech table in accordance with an embodiment of the present disclosure.

FIG. 5 is a diagram of an electronic tech table in accordance with an embodiment of the present disclosure.

FIG. 6 is a diagram of an electronic tech table in accordance with an embodiment of the present disclosure.

### DETAILED DESCRIPTION

Systems and methods described herein provide a steel toolbox with multiple drawers and other features for storing tools. The toolbox may be hydraulically raised and lowered to support a tradesman, for example an electrician, in completing his work. As noted above, a large box for storing many tools is heavy and therefore difficult to move.

An electrician on a ladder or other elevated area does not want to descend to floor level to obtain additional tools. The system provided herein to address such a concern has a hydraulic scissor lift device attached to the bottom of the steel tool box to raise and lower the box, in an embodiment to a maximum height of about eight feet.

The system also provides wheels below the hydraulic scissor lift such that the system may be moved about easily. Such movement may be possible whether the scissor lift is operative and the toolbox therefore elevated or if the tool box is at floor or ground level.

The system also includes rails that may be installed in a parallel fashion inside a flatbed area truck or van to support the toolbox, collapsed scissor lift, and wheels when vehicle is to be driven and the system consequently moved to the next jobsite or to overnight storage. When the toolbox is raised by the scissor lift to the level of the bed of the vehicle, the box may be partially set upon the edge of the bed, the scissor lift may be retracted, and the wheels may be placed upon the parallel rails.

The box may then be rolled into the vehicle on the rails. Once fully inside the vehicle and still on the rails, the box is then secured by a clamping device to prevent the box from moving or rattling about while the vehicle is being moved. This process may be reversed when the box is to be removed from the vehicle. A rechargeable battery in the box may be charged by the vehicle during stowage and transportation.

The wheels are suitable for many kinds of terrain and have brakes and shock absorbers. The box has a 110-volt outlet for tools when fully charged, along with powering LED lighting for nighttime use. A user, for example the aforementioned electrician, may move his tools without placing stress on his back due to the weight of the steel box.

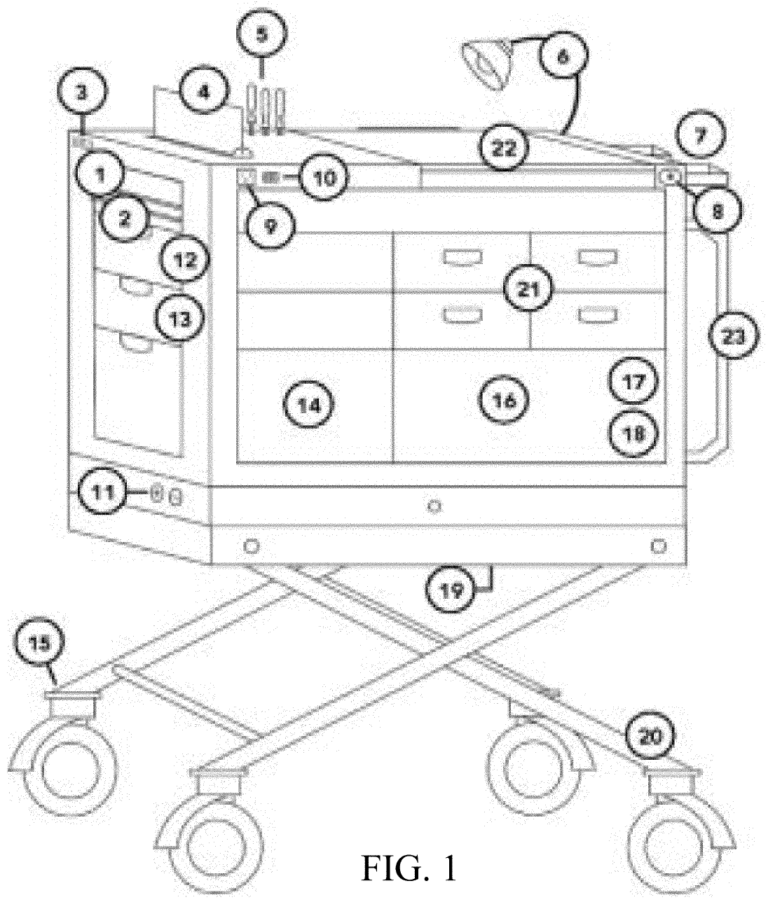

Turning to the figures, FIG. 1 through FIG. 4 illustrate some of the components of systems provided herein. The components shown are as follows:

1. Magnetic Inductive Charge Tray—Drawer 1

2. Magnetic Inductive Charge Tray—Drawer 3

3. LED inductive Charge Indicator

4. Retractable Tablet Pane

5. Screwdriver Grid Panel

6. LED Flex Lamp

7. Drill Slots

8. Bluetooth Signal

9. Outlet

10. 4 Port 120-volt USB

11. Retractor/Expand Buttons

12. Storage Drawer 1

13. Storage Drawer 2

14. Insulated Cooler

15. Click-Pressured Wheel Brake

16. Twin 12-volt internal battery

17. Power invertor

18. Charger

19. Sensored Retracting/Expanding Forklift

20. Stretcher Flexible Retracting Legs

21. Storage

22. Tech Seat

23. Push and Pull Handles.

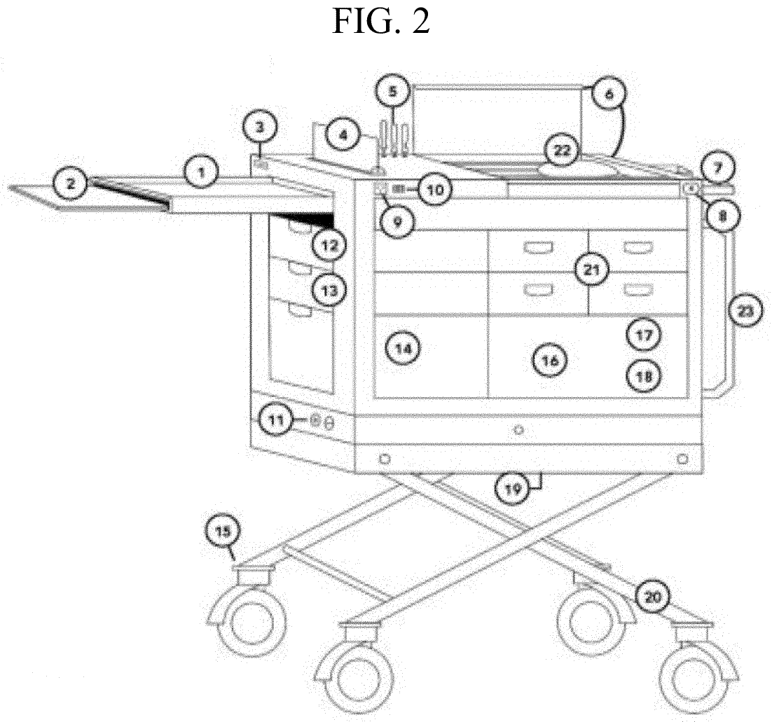

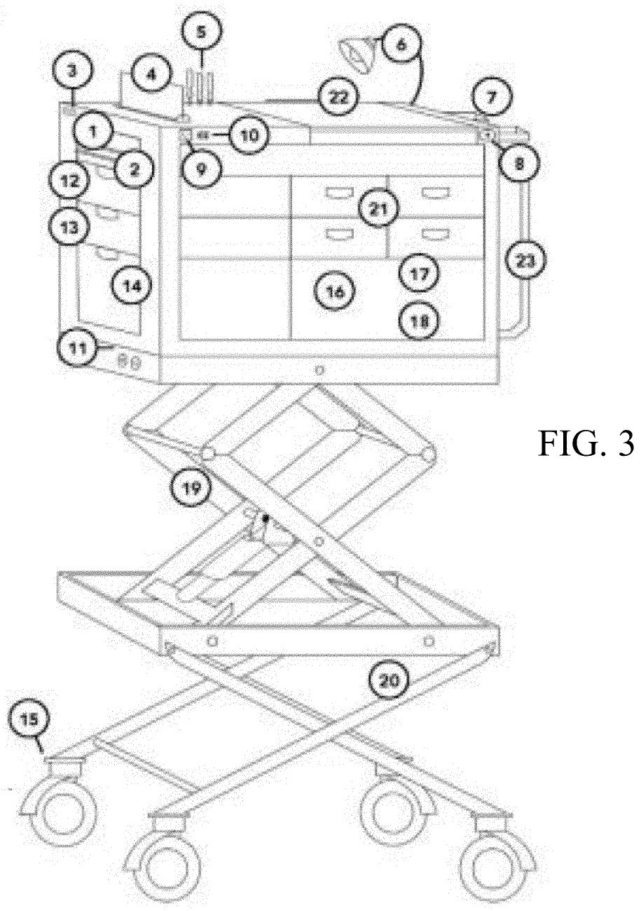

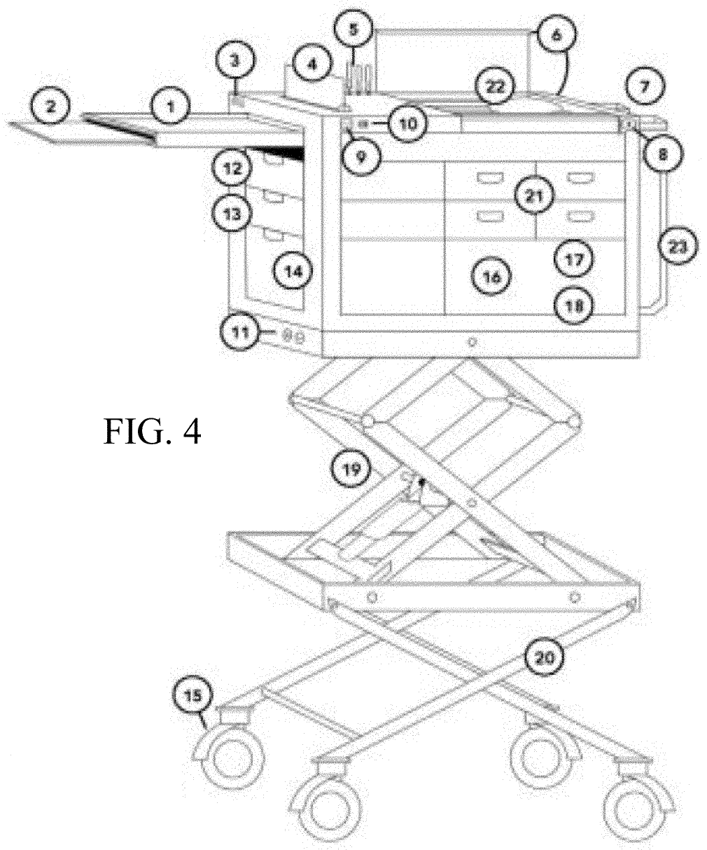

In FIG. 1 and FIG. 2, the Sensored Retracting/Expanding Forklift 19, or forklift 19 for brevity, is not shown as it is in collapsed and retracted state. The box is supported by Stretcher Flexible Retracting Legs 20, or legs 20 for brevity. The forklift 19 is shown in FIG. 3 and FIG. 4.

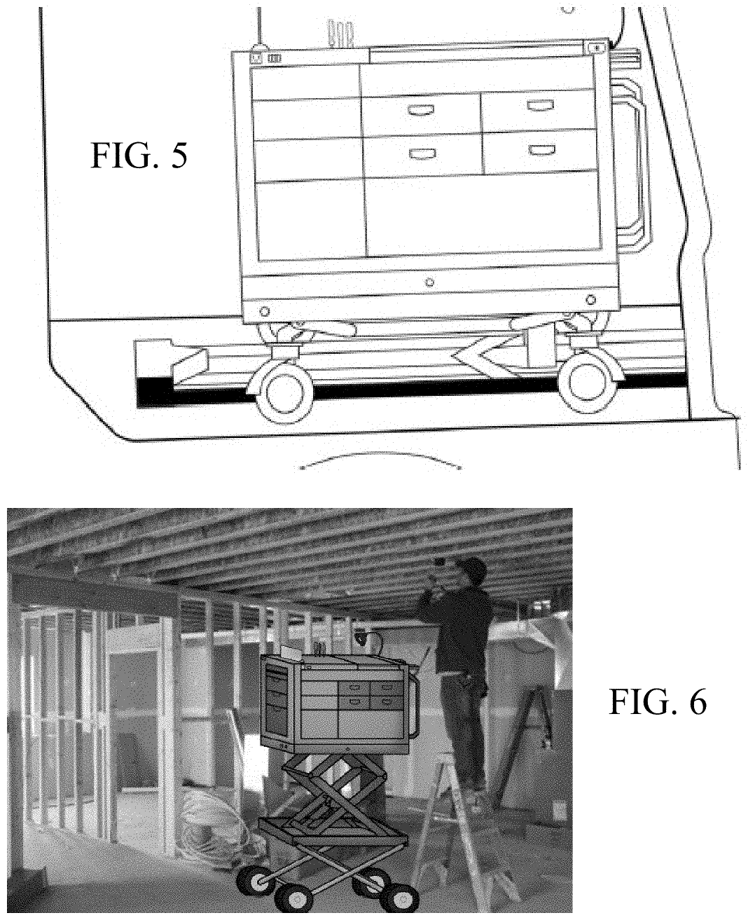

FIG. 5 shows the system in completely collapsed state and situated on rails inside of a truck or van. As noted, the system is physically secured inside the vehicle to minimize the system's movement while the vehicle is in motion. FIG. 6 is a photograph of the system in use.

The system also includes speakers for a user to listen to music or other audio material. The system further includes security locks for drawers and other compartments and mobile device application software to monitor the containers security of the containers as well as Bluetooth and WiFi status, music and container position. Onboard sensors may be installed that communicate with the mobile device application. The system may have other applications that do not directly involve the hydraulic lifting function, for example as a corporate multimedia station equipped with a wall projector and other features as well as a range table for the gun smith and enthusiast at the range.

In embodiments, the system may be controlled remotely by a handheld remote-control device similar to those used with electronic devices and appliances in the home. The system may be equipped with processors, memory, actuators, sensors, communication circuitry, and other components enabling remote control. In embodiments, an app that may execute on a mobile device such as a cell phone may be used to communicate with the system and control raising and lowering of the box and other actions. An electrician on a ladder may move the entire system about a work area as well as raise and lower the box as needed.

What is claimed is:

1. A raisable and lowerable storage system, comprising:
a steel container with multiple compartments;
a scissor lift device attached to at least a bottom area of the container; and
wheels attached to a lower area of the scissor lift device.

2. The system of claim 1, wherein the scissor lift device raises and lowers the container to a desired level.

3. The system of claim 2, wherein the scissor lift device raises the container to a maximum height of about eight feet.

4. The system of claim 1, wherein the wheels support the container as the container is placed into a bed area of a vehicle for transportation.

5. The system of claim 4, wherein the wheels roll along tracks attached to the bed area of the vehicle.

6. The system of claim 4, wherein the container is secured before the vehicle begins moving to prevent the container from rolling about as the vehicle moves.

7. The system of claim 4, wherein a battery in the container is charged while the container is secured and the vehicle moves.

8. The system of claim 1, wherein the container provides at least one electrical outlet for electrical tool connection.

9. The system of claim 1, wherein the scissor lift device is hydraulic.

10. The system of claim 9, where the hydraulic characteristic promotes raising the container to a level even with the bed area of the vehicle.

11. A portable electronic table, comprising:
a steel box with a plurality of storage drawers;
a scissored retracting and expanding forklift device; and
a rechargeable battery for powering at least the forklift device.

12. The system of claim 11, wherein the forklift device raises and lowers the box.

13. The system of claim 11, wherein wheels below the forklift device promote movement of the steel box.

14. The system of claim 12, wherein the forklift device raises the box to a level of a bed of a vehicle.

15. The system of claim 14, wherein once at the level of the bed of the vehicle, the forklift device is retracted and wheels below the forklift device facilitate rolling the box into the vehicle.

16. The system of claim 15, wherein the wheels ride along tracks affixed to the bed of the vehicle.

17. A vehicle-mounted rail system for securing storage devices during transit, comprising:
a vehicle with a horizontal bed surface;
parallel rails affixed to the bed surface, the rails supporting a first storage device; and
a clamping mechanism proximate the rails for affixing the first storage device during vehicle movement.

18. The system of claim 17, wherein the rails support wheels of the first storage device as the device is placed into the vehicle and secured to the clamping mechanism.

19. The system of claim 17, wherein a battery in the first storage device is recharged by the vehicle while the device is stowed and held by the clamping mechanism during movement of the vehicle.

20. The system of claim 17, wherein distance between parallel rails is adjustable based on differing sizes of storage devices to be stowed and transported.
